(19) United States
(12) Patent Application Publication
(10) Pub. No.: US 2021/0405433 A1
(43) Pub. Date: Dec. 30, 2021

(54) DISPLAY PANEL AND MANUFACTURING METHOD THEREOF

(71) Applicant: TCL China Star Optoelectronics Technology Co., Ltd., Shenzhen (CN)

(72) Inventor: Yongchao ZHAO, Shenzhen (CN)

(73) Assignee: TCL China Star Optoelectronics Technology Co., Ltd., Shenzhen (CN)

(21) Appl. No.: 16/758,404

(22) PCT Filed: Dec. 18, 2019
(86) PCT No.: PCT/CN2019/126187

§ 371 Date: Apr. 23, 2020

(30) Foreign Application Priority Data
Dec. 6, 2019 (CN) 201911240997.7

(51) Int. Cl. G02F 1/1333

(52) U.S. Cl. CPC G02F 1/133345; G02F 1/136222; G02F 2201/501

(57) ABSTRACT

A display panel, which is improved based on a structure of an original organic planarization layer. A passivation layer (PV layer) is added between the organic planarization layer and a common electrode layer, which can effectively block a material of the organic planarization layer and ions existing in a material of pixels from entering liquid crystals, thereby improving an ion concentration in the display panel.

### TECHNICAL FIELD

The present application relates to the field of display technology, and more particularly, to a display panel and a manufacturing method thereof.

### BACKGROUND

Liquid crystal display (LCD) devices have become necessities in people's lives. With an increase in people's requirements, in order to improve display quality of display devices, more and more new technologies are being applied to the display devices.

Currently, new technology adopting an organic planarization layer (polymer film on array, PFA) has become a major trend in development of entire LCD panels. Adoption of the organic planarization layer may reduce parasitic capacitance, increase aperture ratio, improve cross talk, planarize topography of film layers, increase contrast, improve properties of subsequent preparation of photoresist coating, and reduce incidence of short circuits in a color filter substrate or an array substrate.

FIG. 1 is a display panel adopting a structure of an PFA in the prior art. The panel includes a substrate 110 of an array substrate, a color filtering layer 140, an organic planarization layer 150, a first common electrode layer 160, liquid crystals 130, a substrate 120 of a color filter substrate, and a second common electrode 170.

A material of the organic planarization layer is mainly organic matter. The organic matter is easily affected by processes such as temperature and illumination, so the organic planarization layer deteriorates and decomposes easily and ions are generated, which eventually leads to an increase in an ion concentration of the entire display panel and affects performance of image sticking.

In light of this, how to relieve the above problems needs to be considered from aspects of materials and manufacturing processes, etc., to reduce the ions generated by the organic planarization layer, thereby relieving the problem of image sticking.

### Technical Problem

The present application provides a display panel, which is improved based on a structure of the original organic planarization layer. A passivation layer (PV layer) is added between the organic planarization layer and a common electrode layer, which can effectively block a material of the PFA and ions existing in a material of pixels from entering liquid crystals, thereby improving an ion concentration in the display panel.

### Technical Solution

According to an aspect of the present application, the present application provides a display panel, comprising an array substrate, a color filter substrate disposed opposite to the array substrate, and liquid crystals disposed between the array substrate and the color filter substrate, wherein on a substrate of the array substrate, the display panel comprises: a color filtering layer, disposed on the substrate; an organic planarization layer, disposed on the color filtering layer; a passivation layer, disposed on the organic planarization layer; and a first common electrode layer, disposed on the passivation layer, wherein a material of the passivation layer is silicon nitride or silicon oxide, and a thickness of the passivation layer is 1500 angstroms to 4500 angstroms.

In an embodiment of the present application, a first polyimide layer is further disposed on the first common electrode layer.

In an embodiment of the present application, a second common electrode layer and a second polyimide layer are sequentially stacked on a substrate of the color filter substrate.

According to another aspect of the present application, the present application provides a display panel, comprising an array substrate, a color filter substrate disposed opposite to the array substrate, and liquid crystals disposed between the array substrate and the color filter substrate, wherein on a substrate of the array substrate, the display panel comprises: a color filtering layer, disposed on the substrate; an organic planarization layer, disposed on the color filtering layer; a passivation layer, disposed on the organic planarization layer; and a first common electrode layer, disposed on the passivation layer.

In an embodiment of the present application, a material of the passivation layer is silicon nitride or silicon oxide.

In an embodiment of the present application, a thickness of the passivation layer is 1500 angstroms to 4500 angstroms.

In an embodiment of the present application, a first polyimide layer is further disposed on the first common electrode layer.

In an embodiment of the present application, a second common electrode layer and a second polyimide layer are sequentially stacked on a substrate of the color filter substrate.

According to another aspect of the present application again, the present application provides a method for manufacturing the display panel, wherein the method comprises steps of: providing a substrate of an array substrate; forming a color filtering layer on the substrate; forming an organic planarization layer on the color filtering layer; forming a passivation layer on the organic planarization layer; and forming a first common electrode layer on the passivation layer.

In an embodiment of the present application, a material of the passivation layer is silicon nitride or silicon oxide.

In an embodiment of the present application, a thickness of the passivation layer is 1500 angstroms to 4500 angstroms.

In an embodiment of the present application, after forming the first common electrode layer, the method further comprises: cleaning the array substrate having the first common electrode layer with a dispersant to remove organic ions generated after the organic planarization layer is prepared.

In an embodiment of the present application, after forming the first common electrode layer, the method further comprises: forming a first polyimide layer on the first common electrode layer.

In an embodiment of the present application, after forming the first polyimide layer, the method further comprises: providing a substrate of a color filter substrate; sequentially forming a second common electrode layer and a second polyimide layer on the substrate of the color filter substrate; and assembling the array substrate and the color filter substrate into a cell and injecting liquid crystals.

### Beneficial Effect

Compared with the prior art, an advantage of the present application is that a display panel described in the present application is improved based on a structure of an original PFA, and a passivation layer (PV layer) is added between the organic planarization layer and a common electrode layer, which can effectively block a material of the PFA and ions existing in a material of pixels from entering liquid crystals, thereby greatly reducing an ion concentration existing in the liquid crystals, while a voltage retention rate can also be improved.

### DESCRIPTION OF DRAWINGS

The following is described in detail in conjunction with the accompanying drawings by the embodiments of the present application, which makes technical solutions and other beneficial effects of the present application obvious.

FIG. 1 is a schematic diagram showing a PFA COA product in the prior art.

FIG. 2 is a schematic structural diagram showing a display device according to an embodiment of the present application.

FIG. 3 is a flowchart of a method for manufacturing a display device according to an embodiment of the present application.

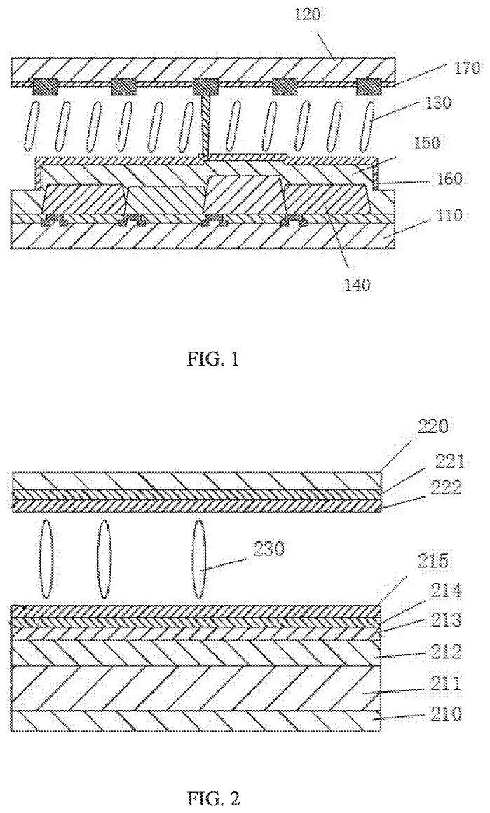

### DETAILED DESCRIPTION OF PREFERRED EMBODIMENTS

The technical solutions in the embodiments of the present application will be clearly and completely described below in conjunction with the drawings in the embodiments of the present application. Obviously, the embodiments described are only a portion of the embodiments of the present application, not all of them. Based on the embodiments in the present application, other embodiments obtained by persons skilled in this art under the premise of no creative efforts made belong to the protection scope of the present application.

In the description of the present application, it should be understood that directional terms or spatially relative terms such as “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise” are orientations or directions with referring to the accompanying drawings, and are merely for describing the present application and illustrating briefly, which does not indicate or imply that a referred equipment or device must have a specific orientation to construct and operate with a specific orientation. Therefore, it cannot be understood as a limitation to the present application. In addition, terms such as “first”, “second” are only used for illustrating objects, and are not to be understood as indicating or implying relative importance or as implicitly including the numbers of technical features referred. Thus, the features defined with “first” and “second” may explicitly or implicitly include one or more of the features. In the description of the present application, “multiple” means two or more, unless explicitly and specifically defined otherwise.

In the description of the present application, it should be explained that unless explicitly stated and limited otherwise, terms “to install”, “to connect”, “connection” should be understood broadly. For example, it may be a fix connection, a detachable connection, or an integral connection; it may be a mechanical connection, an electrical connection, or a mutual communication; it may be directly connected, or may be indirectly connected through an intermediate medium, and may be an internal connection or an interaction relationship of two components. For persons skilled in this art, the specific meanings of the terms described above in the present application may be understood according to specific circumstances.

In the present application, unless explicitly stated and limited otherwise, a description of that a first feature is “above” or “below” a second feature may include the first feature is in direct contact with the second feature, and it may also include the first feature is not in contact with the second feature, but they contact each other through another feature between them. Moreover, a description of that the first feature is “above”, “on”, and “up” the second feature includes that the first feature is directly above and diagonally above the second feature, or it only means that the height level of the first feature is higher than that of the second feature. A description of that the first feature is “below”, “under” and “down” the second feature includes that the first feature is directly below and diagonally below the second feature, or it only means that the height level of the first feature is lower than that of the second feature.

The following disclosure provides many different embodiments or examples for realizing different structures of the present application. In order to simplify the disclosure of the present application, the components and settings of specific examples are described below. Of course, they are merely examples and are not intended to limit the present application. In addition, numbers and/or letters may be referred repeatedly in different examples for the purpose of simplicity and clarity, it does not indicate the relationship between the various embodiments and/or settings discussed. In addition, the present application provides examples of various specific processes and materials, but persons skilled in this art may be aware of the application of other processes and/or the use of other materials.

The present application provides a display panel and a manufacturing method thereof, which are described respectively in detail below.

Referring to FIG. 2, the present application provides a display panel, including an array substrate, a color filter substrate disposed opposite to the array substrate, and liquid crystals disposed between the array substrate and the color filter substrate.

A color filtering layer 211, an organic planarization layer 212, a passivation layer 213, and a first common electrode layer 214 are sequentially stacked on a substrate 210 of the color filter substrate.

The color filtering layer 211 is disposed on the substrate 210 of the array substrate. The substrate 210 may be a thin film transistor array substrate. Specifically, the thin film transistor array substrate includes a base substrate, a buffer layer, and a thin film transistor layer. The base substrate may be a glass substrate or a plastic substrate, but it is not limited thereto. The thin film transistor array substrate is well known to persons skilled in this art, and no further elaboration on details will be made.

A material of the color filtering layer 211 is made of materials of red, green, and blue (RGB) pixels.

The organic planarization layer 212 is disposed on the color filtering layer 211. A material of the organic planarization layer 212 is an organic material, and generally includes: polymer, monomer, photo initiator, solvent, and additive, wherein photosensitive diazonaphthoquinone compound (DNQ) is generally used in the photoinitiator, of which a structure is easily cracked in processes such as light and high-temperature processing and produces sulfate ions, easily causing more ions to exist in the liquid crystals and affecting performance of image sticking.

In order to effectively block ions existing in the materials of the passivation layer 213 and the color filtering layer 211 from entering liquid crystals 230, the passivation layer 213 is disposed on the organic planarization layer 212. A material of the passivation layer 213 is silicon nitride or silicon oxide. Optionally, a thickness of the passivation layer 213 is 1500 angstroms to 4500 angstroms, so that an ion concentration of the display panel can be improved according to the setting.

Continue referring to FIG. 2, the first common electrode layer 214 is disposed on the passivation layer 213.

In the present embodiment, a first polyimide layer 215 is further disposed on the first common electrode layer 214.

In addition, a second common electrode layer 221 and a second polyimide layer 222 are sequentially stacked on a substrate 220 of the color filter substrate. The substrate 220 includes a base substrate, and the base substrate is a glass substrate, but it is not limited thereto.

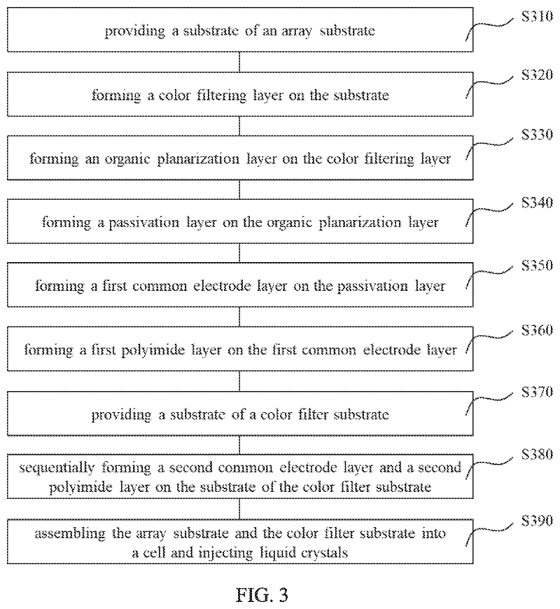

Referring to FIG. 3, the present application provides a method for manufacturing the display panel described above. A specific structure of the display panel is described above, and no further elaboration on details will be made.

The method includes steps of:

Step S310: providing a substrate of an array substrate.

The substrate may be a thin film transistor array substrate. Specifically, the thin film transistor array substrate includes a base substrate, a buffer layer, and a thin film transistor layer. The base substrate may be a glass substrate or a plastic substrate, but it is not limited thereto. The thin film transistor array substrate is well known to persons skilled in this art, and no further elaboration on details will be made.

Step S320: forming a color filtering layer on the substrate.

The color filtering layer 211 is disposed on the substrate of the array substrate. A material of the color filtering layer 211 is made of materials of red, green, and blue (RGB) pixels.

Step S330: forming an organic planarization layer on the color filtering layer.

Step S340: forming a passivation layer on the organic planarization layer.

In order to effectively block ions existing in the materials of the passivation layer 213 and the color filtering layer 211 from entering liquid crystals 230, the passivation layer 213 is disposed on the organic planarization layer 212. A material of the passivation layer 213 is silicon nitride or silicon oxide. Optionally, a thickness of the passivation layer 213 is 1500 angstroms to 4500 angstroms, so that an ion concentration of the display panel can be improved according to the setting.

Step S350: forming a first common electrode layer on the passivation layer.

In the present embodiment, after forming the first common electrode layer 214, the method further includes: cleaning the array substrate having the first common electrode layer 214 with a dispersant (such as NMP) to remove the organic ions generated after the organic planarization layer 212 is prepared. That is, the ions existing in the organic planarization layer 212 generated during the processes described above are dissolved into the dispersant, thereby reducing the ion concentration in the display panel.

In addition, after forming the first common electrode layer, the method further includes step S360: forming a first polyimide layer 215 on the first common electrode layer.

After forming the first polyimide layer, the method further includes steps of:

Step S370: providing a substrate of a color filter substrate.

Step S380: sequentially forming a second common electrode layer 221 and a second polyimide layer 222 on the substrate of the color filter substrate.

Step S390: assembling the array substrate and the color filter substrate into a cell and injecting the liquid crystals 230.

It is found that, comparing the display panel prepared by the processes described above with the display panel in the prior art that only adopts a structure of the organic planarization layer 212, an ion concentration of the display panel in the prior art is 500, while an ion concentration of the display panel described in the present application is only 20, which is much lower than existing products. In addition, a voltage retention rate of the display panel in the prior art is 60%, while a voltage retention rate of the display panel described in the present application can be increased to 95%.

Therefore, an advantage of the present application is that the display panel described in the present application is improved based on the structure of the original PFA, and the passivation layer 213 (PV layer) is added between the organic planarization layer 212 and the common electrode layer, which can effectively block the material of the PFA and the ions existing in the material of pixels from entering the liquid crystals 230, thereby greatly reducing the ion concentration in the liquid crystals, while the voltage retention rate can also be improved.

In the embodiments described above, the description of each of the embodiments has its own emphasis. For a part that is not described in detail in one embodiment, which may refer to related descriptions in other embodiments.

The display device and the manufacturing method thereof provided by the embodiments of the present application have been described in detail above. Specific examples applied are used to explain the principles and the embodiments of the present application in the context. The descriptions of the embodiments described above are only used to help understand the technical solutions of the present application and core ideas thereof. Persons skilled in this art should understand that they still can modify the technical solutions described in the aforementioned embodiments, or equivalently replace some of the technical features. These modifications or replacements do not make the essence of the corresponding technical solutions depart from the scope of the technical solutions of the embodiments of the present application.

1. A display panel, comprising an array substrate, a color filter substrate disposed opposite to the array substrate, and liquid crystals disposed between the array substrate and the color filter substrate, wherein on a substrate of the array substrate, the display panel comprises:
a color filtering layer disposed on the substrate;
an organic planarization layer disposed on the color filtering layer;
a passivation layer disposed on the organic planarization layer; and
a first common electrode layer disposed on the passivation layer,
wherein a material of the passivation layer is silicon nitride or silicon oxide, and a thickness of the passivation layer is 1500 angstroms to 4500 angstroms.

2. The display panel as claimed in claim 1, wherein a first polyimide layer is further disposed on the first common electrode layer.

3. The display panel as claimed in claim 1, wherein a second common electrode layer and a second polyimide layer are sequentially stacked on a substrate of the color filter substrate.

4. A display panel, comprising an array substrate, a color filter substrate disposed opposite to the array substrate, and liquid crystals disposed between the array substrate and the color filter substrate, wherein on a substrate of the array substrate, the display panel comprises:
a color filtering layer disposed on the substrate;
an organic planarization layer disposed on the color filtering layer;
a passivation layer disposed on the organic planarization layer; and
a first common electrode layer disposed on the passivation layer.

5. The display panel as claimed in claim 4, wherein a material of the passivation layer is silicon nitride or silicon oxide.

6. The display panel as claimed in claim 4, wherein a thickness of the passivation layer is 1500 angstroms to 4500 angstroms.

7. The display panel as claimed in claim 4, wherein a first polyimide layer is further disposed on the first common electrode layer.

8. The display panel as claimed in claim 4, wherein a second common electrode layer and a second polyimide layer are sequentially stacked on a substrate of the color filter substrate.

9. A method for manufacturing a display panel, comprising steps of:
providing a substrate of an array substrate;
forming a color filtering layer on the substrate;
forming an organic planarization layer on the color filtering layer;
forming a passivation layer on the organic planarization layer; and
forming a first common electrode layer on the passivation layer.

10. The method as claimed in claim 9, wherein a material of the passivation layer is silicon nitride or silicon oxide.

11. The method as claimed in claim 9, wherein a thickness of the passivation layer is 1500 angstroms to 4500 angstroms.

12. The method as claimed in claim 9, wherein after forming the first common electrode layer, the method further comprises:
cleaning the array substrate having the first common electrode layer with a dispersant to remove organic ions generated after the organic planarization layer is prepared.

13. The method as claimed in claim 12, wherein after forming the first common electrode layer, the method further comprises:
forming a first polyimide layer on the first common electrode layer.

14. The method as claimed in claim 13, wherein after forming the first polyimide layer, the method further comprises:
providing a substrate of a color filter substrate;
sequentially forming a second common electrode layer and a second polyimide layer on the substrate of the color filter substrate; and
assembling the array substrate and the color filter substrate into a cell and injecting liquid crystals.
